(19) United States
(12) Patent Application Publication
(10) Pub. No.: US 2018/0230736 A1
(43) Pub. Date: Aug. 16, 2018

(54) MECHANICAL LOCKING MECHANISM FOR HOLLOW METAL DOORS

(71) Applicant: Charles Richard Treadwell, Gainseville, GU (US)

(72) Inventor: Charles Richard Treadwell, Gainseville, GU (US)

(21) Appl. No.: 15/435,080

(22) Filed: Feb. 16, 2017

(51) Int. Cl. E06B 3/70

(52) U.S. Cl. CPC E06B 3/7015; E06B 2003/7074; E06B 2003/703

(57) ABSTRACT

Implementations of a stiffener joint are provided. In some implementations, the stiffener joint comprises a pair of interlocking beams having a mechanical locking mechanism requiring no welding. In some implementations, the pair of interlocking beams comprises a first beam comprising a plurality of tabs extending from the first beam and forming a hook and a second beam comprising a plurality of opening. The tabs of the first beam extend through the respective openings of the second beam and a portion of the second beam is positioned in the hook formed by the tab of the first beam thereby interlocking the beams. In some implementations, the stiffener joints may be used inside hollow doors.

### TECHNICAL FIELD

This disclosure relates to a mechanical locking mechanism for hollow metal doors.

### BACKGROUND

A hollow door used for example in detention centers has stiffener joints extending the length of the door. The stiffener joints are formed by placing two beams back to back. These beams are welded together along the seam of the two beams. This process can be labor intensive and inefficient thereby increasing the cost of these doors.

### BRIEF DESCRIPTION OF THE DRAWINGS

FIG. 1 illustrates an example implementation of an interior of a hollow door according to principles of the present disclosure.

FIG. 2 illustrates a prior art stiffener joint that may be used in the hollow door of FIG. 1.

FIGS. 3-5 illustrate an example implementation of a stiffener joint used in the hollow door of FIG. 1 according to the principles of the present disclosure.

FIGS. 6A-6C illustrate a cross section of the stiffener joint of FIG. 3 according to the principles of the present disclosure.

FIG. 7 illustrates a portion of a cross-sectional view of the hollow door of FIG. 1.

### DETAILED DESCRIPTION

Implementations of a stiffener joint are provided. In some implementations, the stiffener joint comprises a pair of interlocking beams having a mechanical locking mechanism requiring no welding.

In some implementations, a first beam of the pair of interlocking beams is elongated and when positioned vertically (for orientation purposes to describe the beam), the first beam comprising a first elongated portion extending vertically on a first side of the first beam; a second elongated portion extending vertically on a second side of the first beam; a third elongated portion between and elevated above the first and second portions; a forth elongated portion extending from a first side of the third potion to the first portion; and a fifth elongated portion extending from a second, opposite side of the third portion to the second portion.

In some implementations, the third portion of the first beam comprises a plurality of tabs extending along the length of the third portion. In some implementations, each tab comprises a first segment that extends from the third portion of the first beam at a first angle and a second segment that extends from the first segment at a second angle thereby forming a gap between the second segment of the tab and the third portion of the first beam and a stop formed by the first segment of the tab.

In some implementations, the second beam of the pair of interlocking beams comprises a first portion, second portion, third portion, fourth portion, and fifth portion similar in shape to the first beam except that third portion of the first beam comprises, instead of tabs, a plurality of openings extending along the length of the third portion and configured to receive the tabs of the first beam.

In some implementations, the first beam and the second beam are configured such that when the third portion of the first beam and second beam are placed together and interlocked, the tabs of the first beam extend through the respective openings through the third portion of the second beam and a portion of the third portion of the second beam is positioned in the gap between the second segment of the tab and the third portion of the first beam.

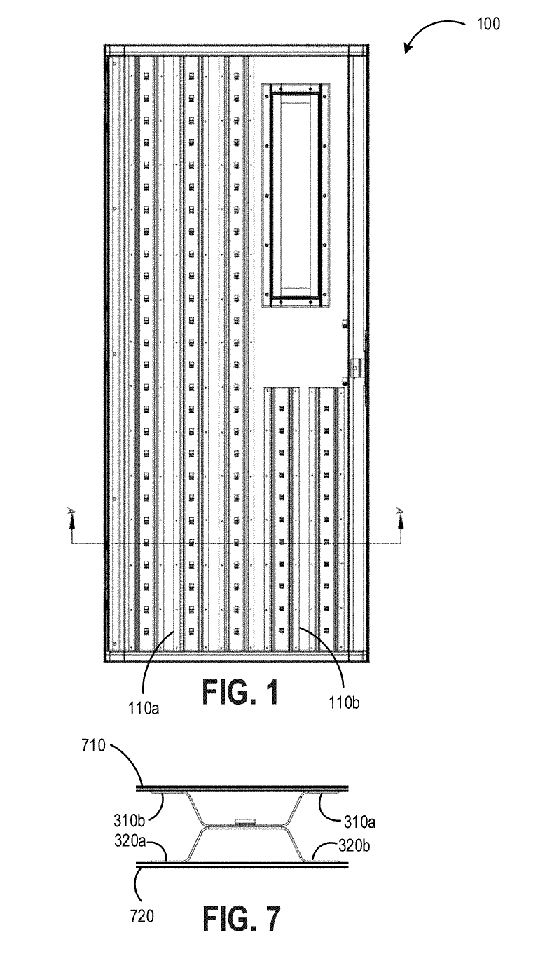

FIG. 1 illustrates an example implementation of an interior of a hollow door according to principles of the present disclosure.

In some implementations, the hollow door comprises a plurality of stiffener joints (e.g., joints 110a, 110b) extending the length (e.g., joints 110a) or a portion of the length (e.g., joints 110b) of the hollow door. In some implementations, the stiffener joints may extend the width or a portion of the width of the hollow door.

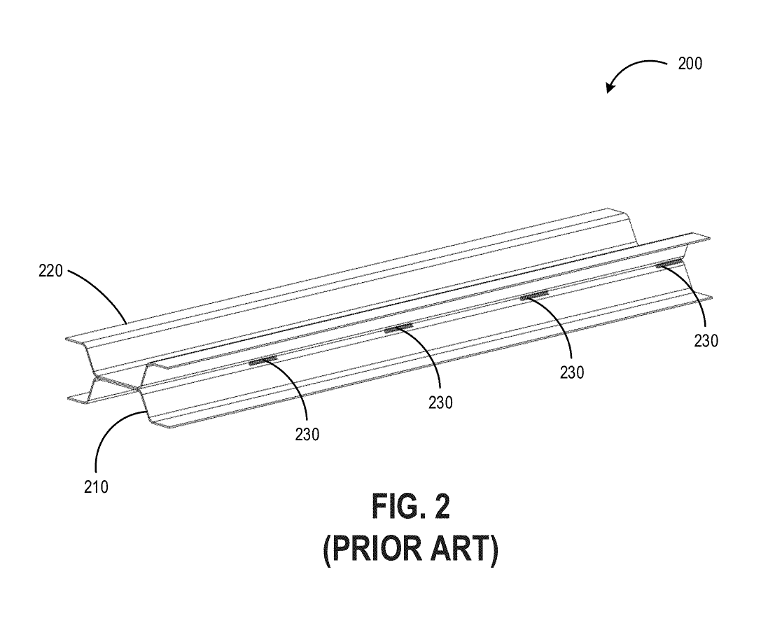

FIG. 2 illustrates a prior art stiffener joint 200 that may be used in the hollow door 100 of FIG. 1. The prior art stiffener joint 200 comprise a first beam 210 and second beam 220 placed back to back and welded at adjacent outer surfaces (e.g., edges) 230 along the length of the beams.

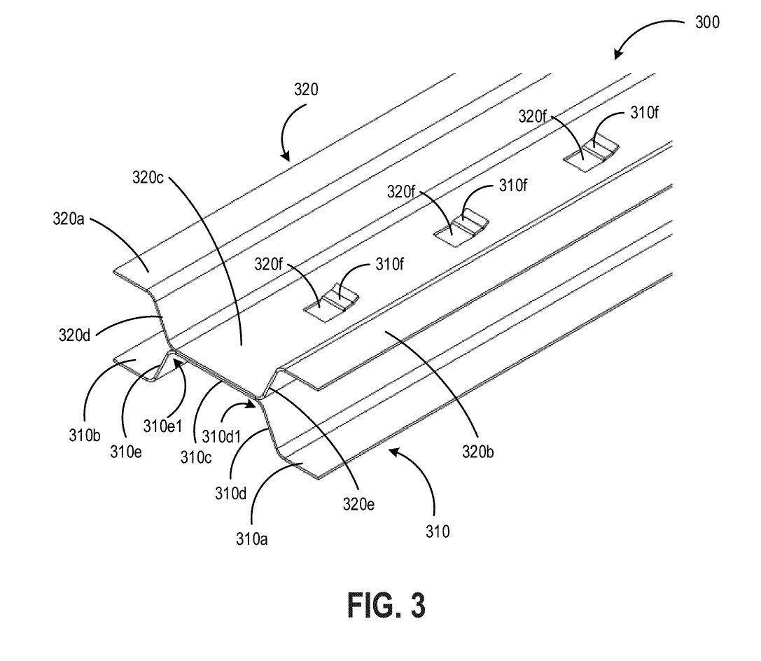

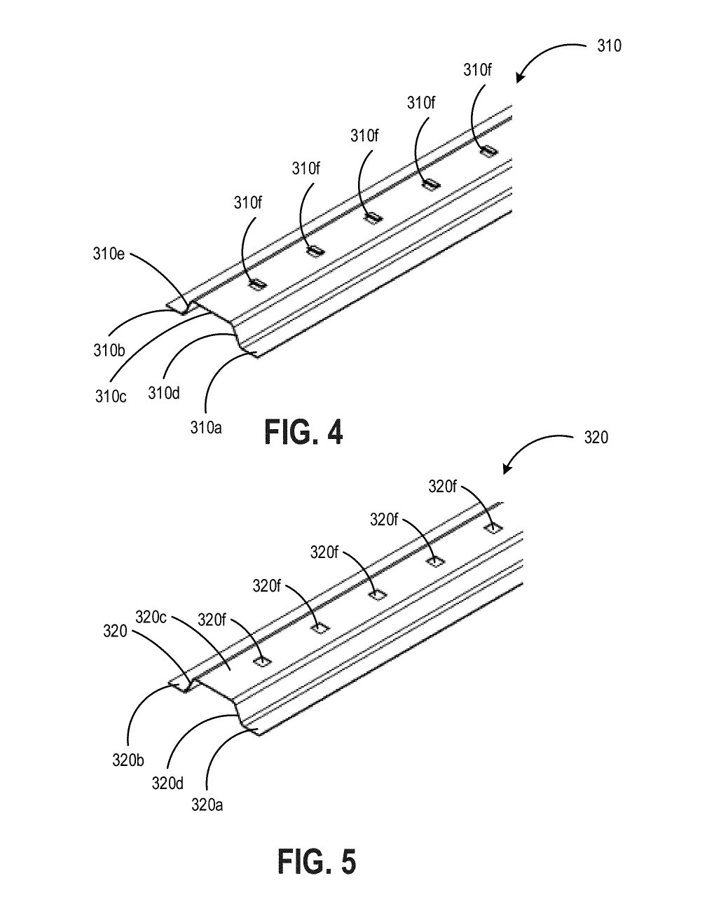

FIGS. 3 and 6A-6C illustrates an example implementation of a stiffener joint 300 used in the hollow door 100 of FIG. 1 according to the principles of the present disclosure. The stiffener joint 300 comprises a first beam 310 and a second beam 320 which in combination have a mechanical locking mechanism 330 secure the beams 310, 320 together. In some implementations, when the first beam 310 and second beam 320 are placed back to back, the stiffener joints 300 comprise no welding to secure the first beam 310 to the second beam. In some implementations, when the first beam 310 and second beam 320 are placed back to back, the stiffener joints 300 may comprise some welding, for example, at adjacent outer surfaces along the length of the beams.

FIG. 4 illustrates an example implementation of the first beam 310 according to the principles of the present disclosure. In some implementations, the first beam 310 is elongated and when positioned vertically (for orientation purposes to describe the beam), the first beam 310 comprises a first elongated portion 310a extending vertically lengthwise on a first side of the first beam 310 and a second elongated portion 310b extending vertically lengthwise on a second side of the first beam 310. In some implementations, the first and second portions are rectangular or generally rectangular. In some implementations, the first and second portions are flat.

The first beam 310 further comprises a third elongated portion 310c that is between and elevated above the first and second portions and extending lengthwise in the same direction as the first and second portions. In some implementations, the third portion 310c is rectangular or generally rectangular. In some implementations, the third portion is flat.

In some implementations, the first beam 310 further comprises a forth elongated portion 310d extending widthwise from a first side of the third potion 310c to the first portion 310a and extending lengthwise in the same direction as the first and second portions. In some implementations, the forth elongated portion 310d extends from the third portion 310c at an angle 310d1 greater than ninety (90) degrees. In some implementations, the forth elongated portion 310d extends from the third portion 310c at an angle 310d1 equal to ninety (90) degrees. In some implementations, the fourth elongated portion 310d extends from the third portion 310c at an angle 310d1 less than ninety (90) degrees.

In some implementations, the first beam 310 further comprises a fifth elongated portion 310e extending widthwise from a second, opposite side of the third portion 310c to the second portion 310b and extending lengthwise in the same direction as the first and second portions. In some implementations, the fifth elongated portion 310e extends from the third portion 310c at an angle 310e1 greater than ninety (90) degrees. In some implementations, the fifth elongated portion 310e extends from the third portion 310c at an angle 310e1 equal to ninety (90) degrees. In some implementations, the fifth elongated portion 310e extends from the third portion 310c at an angle 310e1 less than ninety (90) degrees.

In some implementations, the third portion 310c comprises a plurality of tabs 310f extending along the length or a portion of the length of the third portion 310c. In some implementations, the tabs 310f extend along the center of the third portion 310c. In some implementations, the tabs 310 are equally spaced along the length or a portion of the length of first beam 310.

In some implementations, each tab 310f is formed from a portion of the third portion 310c by cutting out the material from the third portion 310c and forming the tab 310f. Accordingly, as shown in FIG. 6C, in some implementations, the third portion 310c includes an opening 310g through the third portion 310c underneath each tab 310f.

As shown in FIG. 6C, in some implementations, each tab 310f comprises a first segment 310f1 that extends from the third portion 310c at a first angle and a second segment 310f2 that extends from the first segment 310f2 at a second angle to form a gap/opening 310f3 between the second segment 310f2 of the tab 310f and third portion 310c and a stop formed by the first segment 310f1 of the tab 310f. In some implementations, the tab 310f forms an opening that concaves upwardly. In some implementations, each tab 310f includes a third segment 310f4 that extends from the second segment 310f2 at a third angle.

FIG. 5 illustrates an example implementation of the second beam 320 according to the principles of the present disclosure. In some implementations, the second beam 320 comprises a first portion 320a, second portion 320b, third portion 320c, fourth portion 320d, and fifth portion 320e. In some implementations, the first portion 320a, second portion 320b, third portion 320c, fourth portion 320d, and fifth portion 320e are similar in shape to the first beam 310 except that the third portion 320c comprises, instead of tabs, a plurality of openings 320f extending along the length or a portion of the length of the third portion 320c.

In some implementations, the openings 320f are rectangular. In some implementations, the openings 320f are any suitable shape. In some implementations, the openings 320f extend along the center of the third portion 320c. In some implementations, the openings 320f are equally spaced along the length or a portion of the length of second beam 320.

FIGS. 6A-6C illustrate a cross section of the stiffener joint of FIG. 3 according to the principles of the present disclosure. In some implementations, the openings 320f are configured to receive the tabs 310f. More specifically, as shown in FIG. 6C, the tabs 310f of the first beam 310 are configured to extend through the openings 320f when the third portions 310c, 320c of the first beam 310 and second beam 320, respectively, are placed together. When properly interlocked, a portion of the third portion 320c of the second beam 320 can be received by the gap/opening 310f3 and the stop 310f1 can stop the movement of the second beam 320 as discussed in greater detail below.

In some implementations, the first beam 310 and second beam 320 are made from steel. In some implementations, the first beam 310 and second beam 320 can be made from any suitable material.

To lock the first beam 310 and the second beam 320 together, the third portion 310c, 320c of the first beam 310 and second beam 320 are placed together aligning the tabs 310f of the first beam 310 with the openings 320f of the second beam 320 so that the tabs 310f of the first beam 310 extend through the openings 320f of the second beam 320.

Once the tabs 310f on the first beam 310 are placed through the opening 320f in the second beam 320, the second beam 320 is slide in a direction so that a portion of third portion 320c of the second beam 320 is secured between the gap 310f3 formed between the second segment 310f2 of the tab 310f and the third portion 310c of the first beam 310. In some implementations, the second beam 320 is slide in a direction until it is stopped by the first segment 310f1 of the tab 310f of the first beam 310.

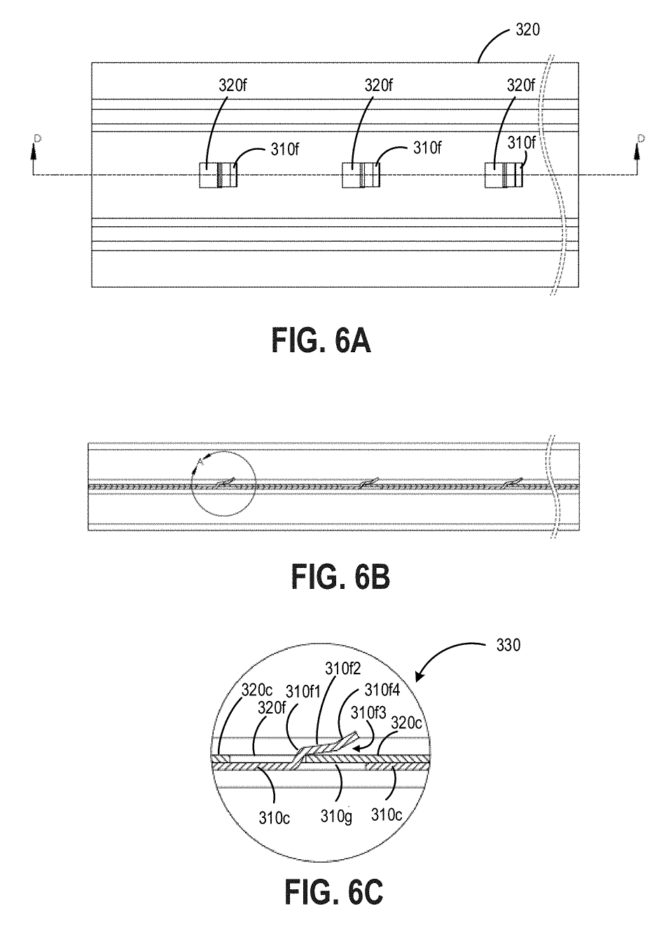

FIG. 7 illustrates a portion of a cross-sectional view of the hollow door of FIG. 1 at line A-A. As shown in FIG. 7, the first portion 310a and second portion 310b of the first beam 310 are attached to a first side 710 of a door. The first portion 320a and second portion 320b of the second beam 320 are attached to the opposite side 720 of the door. In some implementations, the first beam 310 and second beam 320 are attached to the door using a spot weld process. In some implementations, the first beam 310 and second beam 320 are attached to the door using any suitable known or future developed process.

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A door comprising:
a first side, a second side opposite the first side, and a plurality of stiffener joints extending at least a portion of the length of the door between the first side and second side of the door, wherein each stiffener joint comprises:
a first beam wherein the first beam is elongated and positioned vertical between the first side and second side of the door, the first beam comprising a first elongated portion extending vertically lengthwise on a first side of the first beam; a second elongated portion extending vertically lengthwise on a second side of the first beam; a third elongated portion between and elevated above the first and second portions extending lengthwise in the same direction as the first and second portions; a fourth elongated portion extending widthwise from a first side of the third portion to the first portion and extending lengthwise in the same direction as the first and second portions; and a fifth elongated portion extending widthwise from a second side, opposite the first side of the third portion to the second portion and extending lengthwise in the same direction as the first and second portions, wherein the third portion of the first beam comprises a plurality of tabs comprising at least three tabs extending in the same direction and equally spaced along the length of the third portion wherein each tab comprises a first segment that extends from the third portion of the first beam at a first angle and a second segment that extends from the first segment at a second angle thereby forming a gap between the second segment of the tab and the third portion of the first beam and a stop formed by the first segment of the tab; and
a second beam wherein the second beam is elongated and positioned vertical in the door, the second beam comprising a first elongated portion extending vertically lengthwise on a first side of the second beam; a second elongated portion extending vertically lengthwise on a second side of the second beam; a third elongated portion between and elevated above the first and second portions extending lengthwise in the same direction as the first and second portions; a fourth elongated portion extending widthwise from a first side of the third portion to the first portion and extending lengthwise in the same direction as the first and second portions; and a fifth elongated portion extending from a second side, opposite the first side of the third portion to the second portion and extending lengthwise in the same direction as the first and second portions, wherein the third portion of the second beam comprises a plurality of openings comprising at least three opening extending along the length of the third portion of the second beam equally spaced wherein the plurality of openings comprise no projections extending therefrom,
wherein the openings of the third portion of the second beam extend through the third portion and are configured to receive the tabs of the first beam;
wherein the third portion of the first beam and second beam are placed together and the tabs of the first beam extend through the respective openings through the third portion of the second beam and a portion of the third portion of the second beam is positioned in the gap between the second segment of the tab and the third portion of the first beam; and
wherein the first portion and second portion of the first beam are attached to the first side of the door and the first portion and second portion of the second beam are attached to the second side of the door.

2. The door of claim 1 wherein the first, second, and third portions of the first beam and second beam are rectangular.

3. The door of claim 1 wherein the tabs extend along the center of the third portion of the first beam.

4. The door of claim 3 wherein the third portion of the first beam includes an opening through the third portion underneath each tab.

5. The door of claim 3 wherein the openings through the third portion of the second beam are rectangular and extend along the center of the third portion.

6. A pair of interlocking beams comprising:
a first beam wherein the first beam is elongated and when positioned vertically, the first beam comprises a first elongated portion extending vertically lengthwise on a first side of the first beam; a second elongated portion extending vertically lengthwise on a second side of the first beam; a third elongated portion between and elevated above the first and second portions extending lengthwise in the same direction as the first and second portions; a fourth elongated portion extending widthwise from a first side of the third portion to the first portion and extending lengthwise in the same direction as the first and second portions; and a fifth elongated portion extending widthwise from a second side, opposite the first side of the third portion to the second portion and extending lengthwise in the same direction as the first and second portions, wherein the third portion of the first beam comprises a plurality of tabs comprising at least three tabs extending in the same direction and equally spaced along the length of the third portion wherein each tab comprises a first segment that extends from the third portion of the first beam at a first angle and a second segment that extends from the first segment at a second angle thereby forming a gap between the second segment of the tab and the third portion of the first beam and a stop formed by the first segment of the tab; and
a second beam wherein the second beam is elongated and when positioned vertically, the second beam comprises a first elongated portion extending vertically lengthwise on a first side of the second beam; a second elongated portion extending vertically lengthwise on a second side of the second beam; a third elongated portion between and elevated above the first and second portions extending lengthwise in the same direction as the first and second portions; a fourth elongated portion extending widthwise from a first side of the third portion to the first portion and extending lengthwise in the same direction as the first and second portions; and a fifth elongated portion extending from a second side, opposite the first side of the third portion to the second portion and extending lengthwise in the same direction as the first and second portions, wherein the third portion of the second beam comprises a plurality of openings comprising at least three opening extending along the length of the third portion equally spaced of the second beam wherein the plurality of openings comprise no projections extending therefrom,
wherein the openings of the third portion of the second beam extend through the third portion and are configured to receive the tabs of the first beam;
wherein the first beam and the second beam are configured such that when the third portion of the first beam and the third portion of the second beam are placed together and interlocked, the tabs of the first beam extend through the respective openings through the third portion of the second beam and a portion of the third portion of the second beam is positioned in the gap between the second segment of the tab and the third portion of the first beam.

7. The interlocking beams of claim 6 wherein the first, second, and third portions of the first beam and second beam are rectangular.

8. The interlocking beams of claim 6 wherein the tabs extend along the center of the third portion of the first beam.

9. The interlocking beams of claim 8 wherein the third portion of the firm beam includes an opening through the third portion underneath each tab.

10. The interlocking beams of claim 8 wherein the openings through the third portion of the second beam are rectangular and extend along the center of the third portion.

11. A method of interlocking the pair of interlocking beams of claim 6, the method comprising:
positioning the third portion of the first beam and second beam such that the third portions are facing each other;
aligning the tabs of the first beam with the openings of the second beam and inserting the tabs of the first beam through the openings of the second beam;
positioning the second beam so that a portion of the third portion of the second beam is positioned between the gap formed between the second segment of the tab and the third portion of the first beam; and
moving the second beam until it is stopped by the first segment of the tab of the first beam.

12. A method of interlocking the pair of interlocking beams of claim 6, the method comprising:
positioning the third portion of the first beam and second beam such that the third portions are facing each other;
aligning the tabs of the first beam with the openings of the second beam and inserting the tabs of the first beam through the openings of the second beam;
positioning the first or second beam so that a portion of the third portion of the second beam is positioned between the gap formed between the second segment of the tab and the third portion of the first beam; and
moving the first or second beam until the first segment of the tab of the first beam stops the moving beam.

13. A pair of interlocking beams comprising:
a first beam wherein the first beam is elongated and when positioned vertically, the first beam comprises a first elongated portion extending vertically lengthwise on a first side of the first beam; a second elongated portion extending vertically lengthwise on a second side of the first beam; a third elongated portion between and elevated above the first and second portions extending lengthwise in the same direction as the first and second portions; a fourth elongated portion extending widthwise from a first side of the third portion to the first portion and extending lengthwise in the same direction as the first and second portions; and a fifth elongated portion extending widthwise from a second side, opposite the first side of the third portion to the second portion and extending lengthwise in the same direction as the first and second portions, wherein the third portion of the first beam comprises a plurality of tabs comprising at least three tabs extending in the same direction and equally spaced along the length of the third portion wherein each tab comprises a first segment that extends from the third portion of the first beam at a first angle and a second segment that extends from the first segment at a second angle thereby forming a gap between the second segment of the tab and the third portion of the first beam and a stop formed by the first segment of the tab; and
a second beam wherein the second beam is elongated and when positioned vertically, the second beam comprises a first elongated portion extending vertically lengthwise on a first side of the second beam; a second elongated portion extending vertically lengthwise on a second side of the second beam; a third elongated portion between and elevated above the first and second portions extending lengthwise in the same direction as the first and second portions; a fourth elongated portion extending widthwise from a first side of the third portion to the first portion and extending lengthwise in the same direction as the first and second portions; and a fifth elongated portion extending from a second side, opposite the first side of the third portion to the second portion and extending lengthwise in the same direction as the first and second portions, wherein the third portion of the second beam comprises a plurality of openings comprising at least three opening extending along the length of the third portion equally spaced of the second beam,
wherein the openings of the third portion of the second beam extend through the third portion and are configured to receive the tabs of the first beam;
wherein the first beam and the second beam are configured such that when the third portion of the first beam and the third portion of the second beam are placed together and interlocked by positioning the third portion of the first beam and second beam such that the third portions are facing each other; aligning the tabs of the first beam with the openings of the second beam and inserting the tabs of the first beam through the openings of the second beam; positioning the first or second beam so that a portion of the third portion of the second beam is positioned between the gap formed between the second segment of the tab and the third portion of the first beam; and moving the first or second beam until the first segment of the tab of the first beam stops the moving beam, the tabs of the first beam extend through the respective openings through the third portion of the second beam and a portion of the third portion of the second beam is positioned in the gap between the second segment of the tab and the third portion of the first beam and a portion of the second segment of the tab rests on a portion of the third portion of the second beam without any further manual manipulation.
